(19) United States
(12) Patent Application Publication
(10) Pub. No.: US 2007/0138302 A1
(43) Pub. Date: Jun. 21, 2007

(54) RFID tag record for service discovery of UPNP devices and services

(75) Inventor: Zoe Antoniou, Belmont, MA (US)

Correspondence Address: FOLEY & LARDNER LLP, P.O. BOX 80278, SAN DIEGO, CA, 92138-0278, US

(73) Assignee: Nokia Corporation

(21) Appl. No.: 11/591,960

(22) Filed: Nov. 1, 2006

Related U.S. Application Data
(60) Provisional application No. 60/732,739, filed on Nov. 2, 2005.

(51) Int. Cl. G06K 19/06; G08B 13/14

(52) U.S. Cl. 235/492; 340/572.1

(57) ABSTRACT

A RFID tag format for UPnP service discovery. UPnP service discovery is carried out using the SSDP protocol. The tag format provides all the necessary fields of an SSDP service announcement. According to the present invention, the tag contains a record. Each record is a sequence of three elements—a triplet of type, content-length, and content. The record type identifies the structure and semantics of the record by providing the type name. For service discovery, a suitable choice would be the discovery protocol name and version. The content-length identifies the length of the record content. The record content contains the actual data. These are the SSDP presence announcement parameters. The record content includes sub-records which reuse the basic triplet structure. A sub-record is defined for each SSDP parameter.

### FIELD OF THE INVENTION

The present invention relates generally to radio frequency identification (RFID) technology. More particularly, the present invention relates to the use of RFID tags that contain information regarding a device's offered services.

### BACKGROUND OF THE INVENTION

Current networked environments are populated with a diverse set of devices, services and computational entities. Enabling these components to work together harmoniously and allowing users and applications to interact with the components without significant administrative and configuration overhead poses a number of logistical and technical challenges. As a result of these challenges, there has been a substantial amount of research into service location and device interaction technologies, including Serial Link Protocol (SLP), Universal Plug and Play (UPnP), and Jini network technology. With the advent of such location-based services and peer-to-peer computing, service discovery is developing a new role as critical middleware for mobile/ubiquitous computing.

UPnP is a set of protocols for service discovery under development by the Universal Plug and Play Forum, an industry consortium. UPnP standardizes the protocols spoken between clients (referred to herein as control points) and services rather than relying upon mobile code. UPnP is designed to connect networked devices, such as personal computers, entertainment equipment and intelligent appliances. UPnP defines a base set of standards for all devices to adhere to and conventions for describing devices and the services they provide. UPnP leverages existing standards such as TCP/IP, HTTP and XML.

In any network system, it is important that users are able to set network connections, discover devices and services, and send/receive/exchange content easily in an intuitive fashion. RFID is one technology that can easily lend itself to the creation of intuitive and easy-to-use services and applications. RFID is similar in concept to bar coding. RFID can be supplied with read-only or read/write functionality. Radio waves transfer data between an item to which an RFID tag is attached and an RFID reader. In addition, data can be written by a device to an RFID tag attached to an item in order to be read by an RFID reader. There are various implementations of this technology that enable tags to be read either from several feet without a line-of-sight requirement to a few centimeters. Consumer applications focus on closer-range reading, as it offers a more secure and intuitive interface.

The protocol currently referred to as “NDEF” specifies the RFID tag format for communication between a NFC device and another NFC device or contactless memory card. This protocol is applicable to devices that are compliant with the NFC-IP1 or NFC-IP2 specification and the MIFARE Ultralight and FeliCa contactless memory cards. This protocol's specification defines the protocol and the data structure format. The data structure defines the rules of a valid payload.

Traditionally, RFID systems are used for applications such as electronic toll collection, railway track identification and tracking, asset identification and tracking, item management for retail, health care and logistics applications, access control, animal identification, fuel dispensing loyalty programs and automobile immobilization. The use of RFID technology for service discovery, on the other hand, is relative new. Some preliminary implementations of RFID in this area include the use of RFID-enabled mobile devices for payment and ticketing applications. However, there are currently no standardized tag formats (NFC compatible or otherwise) for UPnP service discovery.

### SUMMARY OF THE INVENTION

The present invention describes a compatible tag format for UPnP service discovery, which is carried out using the Simple Service Discover Protocol (SSDP) protocol. The tag format of the present invention provides all of the necessary fields of an SSDP service announcement. The present invention focuses on a particular area of applications and services that use RFID technology to (a) provide more intuitive and convenient user interaction; (b) create new applications and services or enhance the functionality and features of existing ones by enabling convenient service discovery and launch; and (c) provide a compact RFID tag format, keeping memory constraints in perspective.

The present invention provides a number of advantages that have not been previously available. The use of RFID technology in mobile devices introduces a new user experience paradigm for service discovery, initiation and launch (e.g. Touch-and-Click, Point-and-Click). The system of the present invention provides for a convenient, easy and fast solution to service discovery and initiation, as well as a new method to provide service discovery and launch for both existing and new services. In addition, the present invention provides for a compact tag design which allows for the efficient usage of available tag memory size. The present invention provides for a seamless integration in the current UPnP architecture with minimal changes. The present invention can greatly enhance service discovery of UPnP devices through devices such as RFID-equipped mobile handsets, and RFID functionality and applications with Symbian-based devices can also be implemented.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation of the basic tag structure for the data model of the protocol currently identified as NDEF;

FIG. 2 is a representation of the structure of the SSDP record of the basic tag structure of FIG. 1;

FIG. 3 is a representation showing the format of a Name-Length-Value (NLD) field in accordance with the present invention;

FIG. 4 a representation showing text encoding, showing how eight text characters may be stored in seven bytes;

FIG. 5 shows the raw model of the URL NLD according to the present invention;

FIG. 6 shows the raw model of the URL NLD according to the present invention where bit “b” of byte “1” has a value zero, indicating that all bytes beyond byte “2” contain the URL as encoded text;

FIG. 7 is a diagram of the architecture that can be used for the implementation of the present invention;

FIG. 8 is a perspective view of a mobile telephone that can be used in the implementation of the present invention;

FIG. 9 is a schematic representation of the telephone circuitry of the mobile telephone of FIG. 8;

FIG. 10 is a flow chart showing a “touch to print” scenario in which an RFID tag of the present invention may be used;

FIG. 11 is a signal flow diagram showing details of the “touch to print” process of FIG. 10;

FIG. 12 is a flow chart showing a “touch to share” use scenario in which an RFID tag of the present invention may be used;

FIG. 13(a) is a signal flow diagram showing details of the “touch to share” process of FIG. 10 from a sender's perspective, and FIG. 13(b) is a signal flow diagram showing details of the “touch to share” process of FIG. 10 from a receiver's perspective;

FIG. 14 is a flow chart showing a “touch to interact” scenario in which an RFID tag of the present invention may be used; and

FIG. 15 is a signal flow diagram showing details of the “touch to interact” process of FIG. 14.

### DETAILED DESCRIPTION OF THE PREFERRED EMBODIMENTS

The present invention describes an RFID tag format for UPnP service discovery. UPnP service discovery is carried out using the SSDP protocol. The described tag format of the present invention is compliant or compatible with the protocol currently identified as NDEF but it is not limited to this protocol. The tag format provides all of the necessary fields of an SSDP service announcement. By enhancing the current service discovery model, a new paradigm is born that enables a more intuitive and convenient user interaction model with UPnP devices and service in smart spaces. Although the tag size is limited to 256 bytes in one embodiment of the invention, the present invention can be used with any tag size. The need for a compact representation is more pressing with smaller tag sizes.

A SSDP service announcement is the initial service discovery record provided by the tag in order to initiate the discovery process. Given this message, the UPnP control point needs to complete the discovery process by retrieving the root device description document at the URL location provided by the announcement. Once the discovery process is complete, the initiator device can interact with the discovered service (which could comprise another device such as a printer). UPnP does not specify a particular network connection for the above processes.

The discovered service may be accessible through (a) the public network or (b) through a local access point (e.g. Bluetooth, WLAN). The control point device first must establish the network connection, if not already in place before attempting to complete the discovery process. Upon the completion of the service discovery process, the user device may launch the newly discovered service/application.

The basic tag structure of a SSDP service announcement is as follows. The tag contains a record, which is a sequence of three elements—a triplet of record type, record content-length, and record content. The record type identifies the structure and semantics of the Record by providing the type name. For the case of service discovery, a suitable choice would be the discovery protocol name and version. The record content-length identifies the length of the record content. The record content contains the actual data.

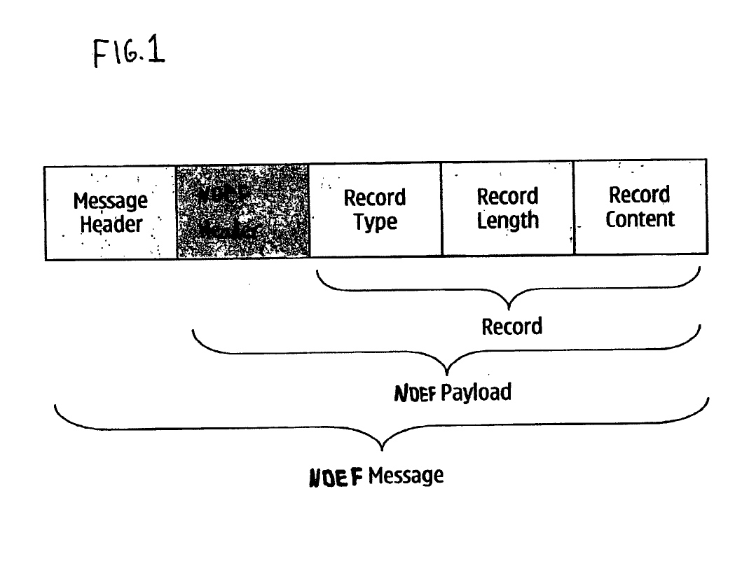

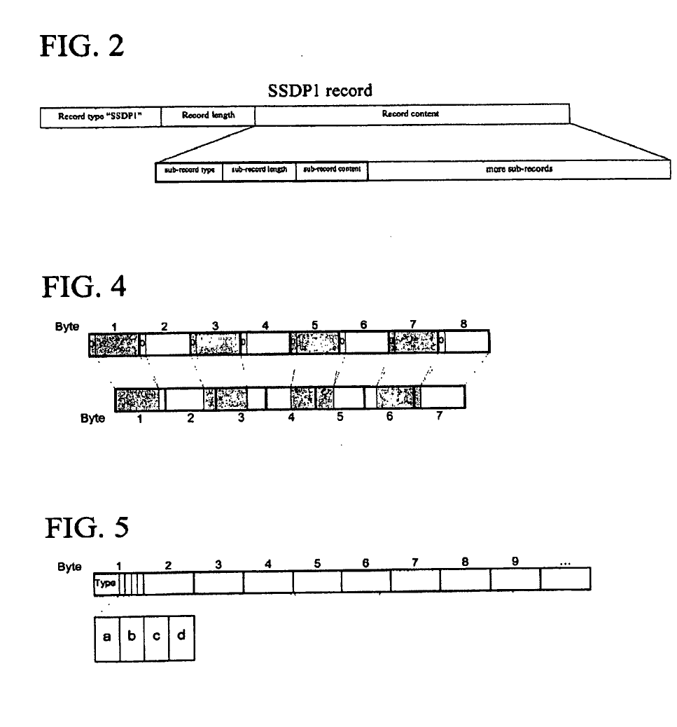

FIG. 1 shows the basic tag structure of the data model for the protocol currently identified as NDEF. In this structure, the message header is attached to the payload portion by the protocol. Only the payload portion is stored on a RFID tag. FIG. 2 shows the structure of the SSDP record. The record content includes sub-records which reuse the basic triplet structure. The type is named “SSDP1” to indicate the version (i.e. ver. 1.0). Table 1 below shows the fields that are included in the SSDP presence announcement. A sub-record is defined for each such parameter. These sub-records are explained below and in Table 2 below.

TABLE 1

| Field | Description | Example Data |
|---|---|---|
| NT | Specifies the potential | “urn:schemas-upnp-org: |
| | search target | device:Printer:1” |
| USN | Composite identifier | “uuid:AAAAAA-AAAA- |
| | for the announcement; | AAAAAA::urn:schemas-upnp- |
| | a concatenation of | org:device:Printer:1” |
| | device ID and value of | |
| | NT | |
| Server | Concatenation of OS | Microsoft-Windows-NT/5.1 |
| | name & version, | UPnP/1.0 UPnP-Device- |
| | UPnP/1.0, product | Host/1.0 |
| | name & version | |
| Location | Points to the location | “http://192.168.64.11: |
| | of UPnP device | 53911/Printer.xml” |
| | description document | |
| | of root device | |
| Cache- | Number of seconds the | 1800 seconds |
| Control | announcement is valid | |
| NTS | Must be ‘ssdp:alive’ | ssdp:alive |

TABLE 2

| Sub Record | | |
|---|---|---|
| Types | Content | Description |
| ‘cc’ | Binary | Cache-control |
| ‘nts’ | Binary | NTS, one of two possible values indicating |
| | | ‘alive’ or ‘bye-bye’ |
| “uuid’ | ASCII | The USN field consists of the ‘uuid’ plus |
| | string | data included in the ‘nt’ sub-record. The |
| | | ‘uuid’ sub-record is used in the |
| | | construction of the USN field. The ‘uuid’ is |
| | | defined as a URI. |
| “ser’ | ASCII | Concatenation of OS name & version, |
| | string. | UPnP/1.0, product name & version |
| “nt’ | Binary | Specifies the device/service type. |
| “u’ | ASCII | URL Location. |
| | string | |

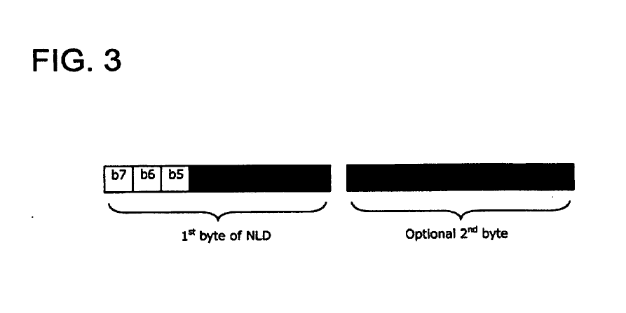

The following is a discussion of the RFID tag record for UPnP (SSDP) service discovery in a compressed format. A compact representation of the SSDP presence announcement sub-record names is presented in FIG. 3. The representation shown in FIG. 3 uses the same basic type-length-content structure. In the record content, there is a collection of sub-records as defined above, i.e. “cc”, “nts”, “ser”, “nt”, “uuid” and “u”. Each sub-record contains a NLD field and a Data field.

The NLD field can be 1-2 bytes long. The format of the first NLD byte is as follows. The first 3 bits (b5-b7, starting from the MSB) is the sub-record name, e.g. “cc”, “nts”, “ser”, “nt”, “uuid” and “u”. The last 5 bits (b0-b4) can represent different parameters depending upon the sub-record. For sub-records “cc” and “nts”, there is only one NLD byte. For the remaining sub-records, the NLD is two bytes long. The sub-record type names are represented by bits [b5-b7] as shown in Table 3 below.

TABLE 3

| Sub-record | Name [b7 b6 b5] |
|---|---|
| RFU | 0 0 0 |
| cc | 0 0 1 |
| nts | 0 1 0 |
| ser | 0 1 1 |
| nt | 1 0 1 |
| uuid | 1 0 1 |
| u | 1 1 0 |
| RFU | 1 1 1 |

The NLD field is 1 byte long. If b4=1 then bytes [b3-b0] contain the value of the cache-control sub-record based upon a pre-defined table. An example of such a table follows as Table 4 below. The minimum legal value is 0.5 hours or 1800 secoonds. If b4=0, then the data field length is contained in bytes [b3-b0]. This allows for 2⁴=16 bytes maximum data field length. The data field with a binary value follows.

TABLE 4

| Name: cc | | | Read from | [b3-b0] Encoded | | | | | |
|---|---|---|---|---|---|---|---|---|---|
| (Cache Control) | | | Table | Default Value | | | | Cache | |
| b7 | b6 | b5 | b4 | b3 | b2 | b1 | b0 | Control Value | |
| 0 | 0 | 1 | 1 | 0 | 0 | 0 | 0 | 0.5 | hours |
| 0 | 0 | 1 | 1 | 0 | 0 | 0 | 1 | 1 | hour |
| 0 | 0 | 1 | 1 | 0 | 0 | 1 | 0 | 2 | hours |
| 0 | 0 | 1 | 1 | 0 | 0 | 1 | 1 | 6 | hours |
| 0 | 0 | 1 | 1 | 0 | 1 | 0 | 0 | 12 | hours |
| 0 | 0 | 1 | 1 | 0 | 1 | 0 | 1 | 24 | hours |
| 0 | 0 | 1 | 1 | 0 | 1 | 1 | 0 | 2 | days |
| 0 | 0 | 1 | 1 | 0 | 1 | 1 | 1 | 3 | days |
| 0 | 0 | 1 | 1 | 1 | 0 | 0 | 0 | 5 | days |
| 0 | 0 | 1 | 1 | 1 | 0 | 0 | 1 | 7 | days |
| 0 | 0 | 1 | 1 | 1 | 0 | 1 | 0 | 14 | days |
| 0 | 0 | 1 | 1 | 1 | 0 | 1 | 1 | 30 | days |
| 0 | 0 | 1 | 1 | 1 | 1 | 0 | 0 | 2 | months |
| 0 | 0 | 1 | 1 | 1 | 1 | 0 | 1 | 3 | months |
| 0 | 0 | 1 | 1 | 1 | 1 | 1 | 0 | 6 | months |
| 0 | 0 | 1 | 1 | 1 | 1 | 1 | 1 | 12 | months |

The NTS sub-record uses only one byte needed for both NLD and data fields. As discussed above, the “nts” sub-record can take one of two possible values, “ssdp:bye-bye” and “ssdp: alive”. “ssdp” alive” is of interest in the case of service discovery. Table 5 below explains its format.

TABLE 5

| Name: NTS | | | [b4-b0] Encoded Value | | | | | |
|---|---|---|---|---|---|---|---|---|
| b7 | b6 | b5 | b4 | b3 | b2 | b1 | b0 | Value |
| 0 | 1 | 0 | 0 | 0 | 0 | 0 | 0 | ssdp:bye-bye |
| 0 | 1 | 0 | 0 | 0 | 0 | 0 | 1 | ssdp:alive |

The server sub-record is a concatenation of operating system name & version, UPnP/1.0, product name & version. The sub-record type is defined as ‘ser’. If this sub-record is to be represented in a string format, it will have a variable length and can be very expensive in terms of the number of bytes needed. As an alternative, bit b4 of the NLD byte can be used to indicate the following:
if b4=0, then only the UPnP version number is included in the server sub-record. Possible representation is a second byte, where bits [b7-b4] represent the major number and bits [b3-b0] represent the minor number.
If b4=1, then the operating system and product names and versions are included. These can be represented in string format, or a table can be defined to map binary values to names. For example,
OS name: 1 byte
OS version: 1 byte (major and minor enumerations)
UPnP/1.0 (or subsequent versions): 1 byte
Product name: 1 byte
Product version: 1 byte

The sub-record therefore consists of one NLD byte for the name and five bytes for the data field in a pre-defined sequence as specified above.

A third alternative is to define each field in either binary value or string format. For example, the NLD byte of the “ser” sub-record can be defined as: 011 x x x x x. The first 3 bits are the name, and the last 5 can represent each one of the above categories and denote whether their value is given in a binary or string format. If the value is equal to “0”, then it is read as binary value, one byte per category in a pre-defined sequence. If the value is equal to “1”, then it is read as a string, with the first byte giving the length of the string. Therefore, a NLD byte of 01100011 implies that only the product name and version are given in string format. This method is more comples than those discussed previously but also allows for more flexibility.

The NT sub-record is a notification type defined as ‘nt’. The sub-record lenght is variable depending on the content length. The sub-record content may take one of the following forms:
upnp:rootdevice
uuid:device-UUID
urn:schemas-upnp-org:device:deviceType:ver
urn:schemas-upnp-org:service:serviceType:ver

The NLD byte can be 1-2 bytes long. If the UUID is required in this field, it is provided by the “uuid” sub-record separately. Table 6 below shows the “nt” sub-represented record as represented by a combination of NLD bytes and strings.

TABLE 6

| Name = NT | | | [b4-b0] Encoded Value | | | | | |
|---|---|---|---|---|---|---|---|---|
| b7 | b6 | b5 | b4 | b3 | b2 | b1 | b0 | Value |
| 1 | 0 | 1 | 0 | 0 | 0 | 0 | 0 | Read string whose length is |
| | | | | | | | | given by the 2^{nd} NDL byte |
| 1 | 0 | 1 | 1 | 0 | 0 | 0 | 0 | upnp:rootdevice (No 2^{nd} NDL |
| | | | | | | | | byte) |
| 1 | 0 | 1 | 1 | 0 | 1 | 0 | 0 | uuid:device-UUID (from UUID |
| | | | | | | | | field) (No 2^{nd} NDL byte) |
| 1 | 0 | 1 | 1 | 1 | 0 | 0 | 0 | urn:schemas-upnp-org:device: |
| | | | | | | | | Read string deviceType:ver |
| | | | | | | | | (length by 2^{nd} NDL byte) |
| 1 | 0 | 1 | 1 | 1 | 1 | 0 | 0 | urn:schemas-upnp-org:service: |
| | | | | | | | | Read string serviceType:ver |
| | | | | | | | | (length by 2^{nd} NDL byte) |

If b4=0, NT is given in string format. There is a second NLD byte to represent the length of the data field. The length field specifies the number of bytes in the data field and not the number of text-characters. Furthermore, this field is written as an encoded number and might take up more than one byte.

If b4=1, then Table 6 is used. In this situation, if b3=0, then NDL is one byte long. If b3=0 and b2=0, then NT=upnp:rootdevice. If b3=0 and b2=1, then NT=uuid:device-UUID. This is read from the ‘uuid’ sub-record. If b3=1, then NDL=2 bytes long. If b3=1 and b2=0, then NT=urn:schemas-upnp-org:device: deviceType:ver. In this case, the string deviceType:ver (string length given by 2nd NDL byte) is read. If b3=1 and b2=1, then NT=urn:schemas-upnp-org:service: serviceType:ver. In this case, the string serviceType:ver (string length given by 2nd NDL byte) is read. The data in the “nt” sub-record is combined with the UUID to create the USN of the UPnP presence announcement.

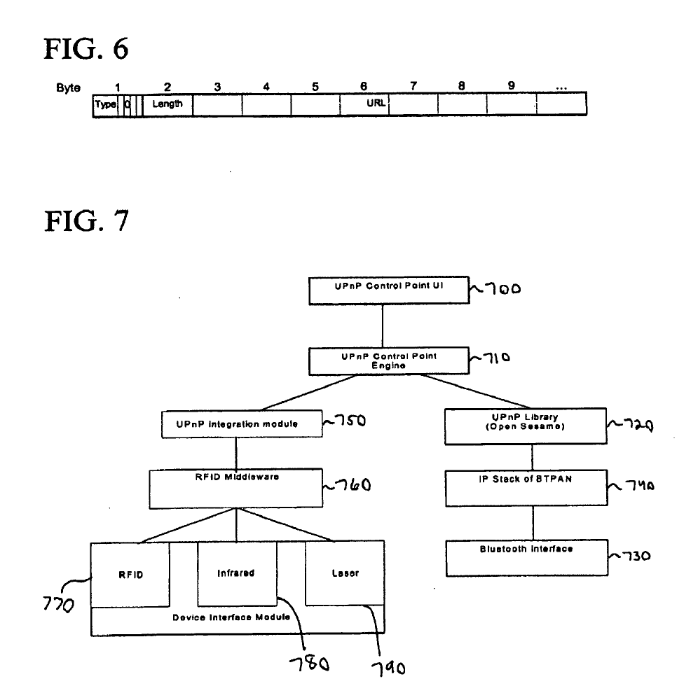

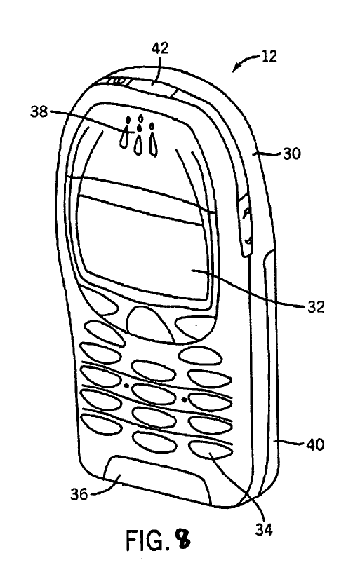

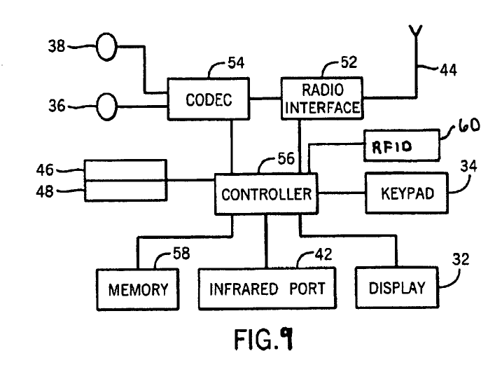

The UUID sub-record can be one of the longest sub-records. There are 2 bytes for the NLD field. The second NLD byte represents the data field (string) length. The data field is of variable length depending upon the content length. The sub-record content is ASCII.For the location sub-record, the following is one method for compressing the location URL. Valid text-characters for URLs lie in the range of 0x20 to 0x7F. Therefore, it is possible to use only 7 bits for each character by leaving away the msb. Consequently, one can store 8 text-characters in 7 bytes, as is suggested in FIG. 4. When the length of an encoded text is specified, it stands for the number of bytes and not for the number of characters.

Numbers are encoded to use as few bytes as possible. The first two bits specify how many bytes the number consists of. The remaining bits contain the number. The number encoding is depicted in Table 7 below.

TABLE 7

| | Size | | |
|---|---|---|---|
| MSBs | (Bytes) | Range | Layout |
| 00 | 1 | 0 . . . 0×3F | 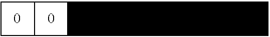 |
| 01 | 2 | 0×40 . . . 0×3FFF | 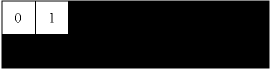 |
| 10 | 3 | 0×4000 . . . 0×3FFFFF | 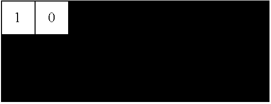 |
| 11 | 4 | 0×400000 . . . 0×3FFFFFFF | 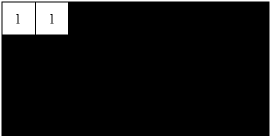 |

For sub-record “u” encoding, the URL NLD uses text-encoding to compress the URL. A bit indicates whether the text should be prepended with ‘http://’, such that this string does not have to be included as text. In addition, if the URL contains an IP-address (and port), these are-written as binary data and not as encoded text.

FIG. 5 shows the raw model of the URL NLD. The first byte contains the type (3 MSB bits), one blank bit and default-data (4 LSB bits). The bits of the default data are defined as follows. For bit a, if the bit is ‘1’, the resulting URL is prefixed with “http://”. Otherwise, it is ignored. For bit b, if the bit is ‘0’, bits c and d are ignored. In this case, byte 2 contains the length (as encoded number). The remaining bytes contain the URL as encoded text. Byte 2 is depicted in FIG. 6. If bit b is “1”, then bits c and d are used to indicate binary representations of the IP-address and the port. Table 8 below depicts the various byte layouts for different values of bit b, c and d.

TABLE 8

| b | c | d | Layout |
|---|---|---|---|
| 1 | 0 | 0 | 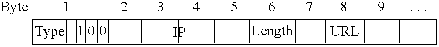 |
| | | | String-representation: ['http://']<IP>'/'<URL> |
| | | | The IP-address is written in binary from to the Bytes 2-5. This instance is |
| | | | used if no port is specified. The slash after the IP-address is implicit and |
| | | | must not be repeated in the <URL>. |
| 1 | 0 | 1 | 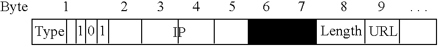 |
| | | | ['http://']<IP>':'<Port>'/'<URL> |
| | | | The IP-address is written in binary from to the Bytes 2-5 and the port to |
| | | | the Bytes 6-7. The slash after the port-number is implicit and must not |
| | | | be repeated in the <URL>. |
| 1 | 1 | 0 | 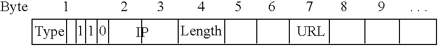 |
| | | | ['http://']'192.168.'<IP>'/'<URL> |
| | | | Only the two LSB of the IP-address are specified. This instance is used |
| | | | when the MSB of the IP-address is 192.168 and no port is specified. |
| | | | The slash after the IP- address is implicit and must not be repeated in |
| | | | the <URL>. |
| 1 | 1 | 1 | 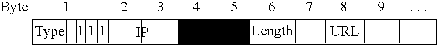 |
| | | | ['http://']'192.168.'<IP>':'<Port>'/'<URL> |
| | | | Only the two LSB of the IP-address are specified. This instance is used |
| | | | when the MSB of the IP-address is 192.168 and a port-number is speci- |
| | | | fied. The slash after the port-number is implicit and must not be repeated |
| | | | in the <URL>. |

The following Table 9 is the compressed representation of the same simple SD record as in the example of Table 1. The 8 to 7 bit encoding per character is not used in this case.

TABLE 9

| Content | Length | Explanation | Syntactical information | |
|---|---|---|---|---|
| 0x34 | 1 | The length of the NFC | NDEF header | |
| | | message (52 bytes) | | |
| 0x02 “SD” | 3 | Record type: “SD” (+1 byte | Service | Service |
| | | for string length) | Discovery | Discovery |
| 0x30 | 1 | Length of the Service | Application | header (=the |
| | | Discovery data (48 bytes) | data | standard |
| | | | | NFC record |
| | | | | header) |
| 0x05 | 6 | Record type: “Ssdp1” | | The Service |
| “SSDP1” | | (=SSDP1, +1 byte for string | | record of this |
| | | length) | | Service |
| 0x29 | 1 | Length of the SSDP1 record | | Discovery = a |
| | | (41 bytes) | | simple |
| 0x30 | 1 | Sub-record type: “cc” (1 byte | | SSDP1 |
| | | for NLD and Data fields). | | record. |
| | | Sub-record content (1800 | | |
| | | seconds) | | |
| 0x41 | 1 | Sub-record type: “nts” (1 byte | | |
| | | for NLD and Data fields). | | |
| | | Sub-record content | | |
| | | “ssdp:alive”. | | |
| 0x60 0x10 | 2 | Sub-record type: “ser” (1 byte | | |
| | | for NLD & 1 byte for Data | | |
| | | assuming that only UPnP | | |
| | | version 1.0 is included, i.e. | | |
| | | NLD = 01100000, Data = | | |
| | | 00010000) | | |
| 0xB0 | 1 | Sub-record type: “nt” (1 byte | | |
| | | for NLD abd Data fields, no | | |
| | | string required in this case). | | |
| | | Sub-record content = | | |
| | | upnp:rootdevice | | |
| 0x38 0x12 | 2 | Sub-record type: “uuid” (2 | | |
| | | bytes for the NLD field) | | |
| “AAAAAA- | 18 | Sub-record content (ASCII) | | |
| AAAA- | | | | |
| AAAAAA” | | | | |
| 0xCF | 16 | Sub-record type: “u” NLD + | | |
| 0x40 0x0B | (NLD | Data fields. The URL is | | |
| 0xCF 0x08 | byte) | “http://192.168.64.11:53000/ | | |
| “Printer.xml” | (2 IP | Printer.xml” | | |
| | LSB | | | |
| | bytes) | | | |
| | (2 Port # | | | |
| | bytes) | | | |
| | (string) | | | |

The following is a discussion of the RFID tag record for UPnP service discovery in an uncompressed format. The cache-control max age sub-record type is defined as ‘cc’. The sub-record length is one byte and gives the length of the sub-record content. The sub-record content is binary and represents the number of seconds the announcement is valid. The legal minimum value is 1800 seconds.

The NTS sub-record can be one of two possible values: ‘ssdp:alive’ or ‘ssdp:bye-bye’. The former is used in the case of presence announcements. The sub-record type is defined as ‘nts’. The sub-record length is one byte. The sub-record content is binary and its value is ‘1’ for ‘alive’ and ‘0’ for ‘bye-bye’.

The server sub-record is a concatenation of operating system name & version, UPnP/1.0, product name & version. The sub-record type is defined as ‘ser’. The sub-record length is variable depending on the content length. The sub-record content is an ASCII string.

The NT sub-record is a notification type defined as ‘nt’. The sub-record length is variable depending on the content length. The sub-record content may take one of the following forms:
upnp:rootdevice
uuid:device-UUID
urn:schemas-upnp-org:device:deviceType:ver
urn:schemas-upnp-org:service:serviceType:ver

A combination of binary values and strings can be used to represent the NT sub-record in a compact fashion. These values and strings are as follows.
The first byte of sub-record content is ‘00000001’ for: upnp:rootdevice
The first byte of sub-record content is ‘00000010’ for: uuid:device-UUID. “UUID” is taken from the ‘uuid’ sub-record.
The first byte of sub-record content is ‘00000011’ for: urn:schemas-upnp-org:device:deviceType:ver. deviceType:ver is included in string format in the following bytes of the sub-record content.
The first byte of sub-record content is ‘00000100’ for: urn:schemas-upnp-org:service:serviceType:ver. serviceType:ver is included in string format in the following bytes of the sub-record content.

The SSDP presence announcement has a USN field which is a concatenation of the device ID (uuid) and the NT value. This field may take one of the following forms:
uuid:device-UUID::upnp:rootdevice
uuid:device-UUID
uuid:device-UUID::urn:schemas-upnp-org:device:deviceType:ver
uuid:device-UUID::urn:schemas-upnp-org:service:serviceType:ver

It is only necessary to include a ‘uuid’ sub-record which can be used together with the ‘NT’ sub-record to reconstruct the USN field. The sub-record type is defined as ‘uuid’. The sub-record length is variable depending upon the content length. The sub-record content is ASCII.

The location sub-record content contains the URL where the device description XML document is stored. The sub-record type is defined as ‘u’. The sub-record length is variable depending on the content length. The sub-record content is an ASCII string. It should be noted that ‘u’ can be replaced by the NFC-defined URI type if needed.

The following Table 10 is an example of a “SSDP1” sub-record for a tag format for UPnP service discovery without any compression.

TABLE 10

| | | | Syntactical |
|---|---|---|---|
| Content | Length | Explanation | information |
| 0x05 | 6 | Record type: “Ssdp1” | The |
| “SSDP1” | | (=SSDP1, +1 byte | Service |
| | | for string length) | record of |
| 0x40 0x8A¹ | 2 | Length of the SSDP1 | this |
| | | record (138 bytes) | Service |
| 0x02 “cc” | 3 | Sub-record type: | Discovery = |
| | | “cc” (=cc, +1 byte | a simple |
| | | for string length) | SSDP1 |
| 0x02 | 1 | Sub-record content | record. |
| | | length (2 bytes) | |
| 0x07 0x08 | 2 | Sub-record content | |
| | | (1800 seconds) | |
| 0x03 “nts” | 4 | Sub-record type: | |
| | | “nts” (=nts, +1 byte | |
| | | for string length) | |
| 0x01 | 1 | Sub-record content | |
| | | length (1 byte) | |
| 0x01 | 1 | Sub-record content | |
| | | (binary value 1, | |
| | | “ssdp:alive”) | |
| 0x03 “ser” | 4 | Sub-record type: | |
| | | “ser” (=ser, +1 byte | |
| | | for string length) | |
| 0x35 | 1 | Sub-record content | |
| | | length (53 bytes) | |
| “Microsoft- | 53 | Sub-record content | |
| Windows- | | (assume ASCII | |
| NT/5.1 | | in this case) | |
| UPnP/1.0 | | | |
| UPnP- | | | |
| Device- | | | |
| Host/1.0” | | | |
| 0x02 “nt” | 3 | Sub-record type: | |
| | | “nt” (=nt, +1 byte | |
| | | for string length) | |
| 0x01 | 1 | Sub-record content | |
| | | length (1 byte) | |
| 0x01 | 1 | Sub-record content | |
| | | (binary value of | |
| | | 1 = upnp:rootdevice) | |
| 0x04“uuid” | 5 | Sub-record type: | |
| | | “uuid” (=uuid, | |
| | | +1 byte for string | |
| | | length) | |
| 0x12 | 1 | Sub-record content | |
| | | length (18 bytes) | |
| “AAAAAA- | 18 | Sub-record content | |
| AAAA- | | (ASCII) | |
| AAAAAA” | | | |
| 0x01 “u” | 2 | Sub-record type: | |
| | | “u” (=u, +1 byte | |
| | | for string length). | |
| | | Assume a locally | |
| | | scoped sub-record | |
| | | definition. | |
| 0x24 | 1 | Sub-record content | |
| | | length (36 bytes) | |
| “http://192. | 36 | Sub-record content | |
| 168.64.11: | | or URI field | |
| 53911/ | | (ASCII) | |
| Printer.xml” | | | |

FIG. 7 is a diagram of the architecture that can be used for the implementation of the present invention. A user interface 700 (UI) can comprise a graphical user interface for a UPnP control point engine 710. The UPnP control point engine 710 is the engine which maintains the discovered UPnP devices and performs the UPnP services. This component can also initiate and complete the discovery process. A UPnP library 720, also referred to as an “open sesame” UPnP library, is used for UPnP implementation, providing an application program interface (API) to the UPnP control point engine 710. It should be noted that the “open sesame” UPnP library is just one example of a UPnP library, and that other types of UPnP libraries are also possible. A Bluetooth interface 730 is used to connect to the desired access point and to provide IP connectivity to different UPnP devices. An IP Stack of BTPAN 740 provides the IP stack over Bluetooth so that the UPnP library 720 can perform operations of the respective IP network. A UPnP integration module 750 provides an application program interface (API) to RFID middleware 760 (also sometimes referred to as a Demux & Conversion module). The UPnP integration module 750 is also used as the integration module in the UPnP control point engine 710. The RFID middleware 760 comprises a RFID middleware layer. This item also receives tag data, deduces the appropriate discovery protocol, formats the data and passes it to the corresponding integration module. This initiates the discovery process. A RFID device interface module 770 acts as a reader which reads data from a tag attached to another object or device. It is also possible for this module to include a tag that data can be written to in order to be read by other devices acting as readers. Other types of interfaces, such as an IR interface 780 and a laser interface 790, may also be included in addition to or instead of the RFID device interface module 770.

FIGS. 8 and 9 show one representative mobile telephone 12 within which the present invention may be implemented. It should be understood, however, that the present invention is not intended to be limited to one particular type of mobile telephone 12 or other electronic device. Instead, the present invention can be incorporated into virtually any type of electronic device, including but not limited to laptop and desktop computers, personal digital assistants, integrated messaging devices, printers, scanners, fax machines and other devices.

The mobile telephone 12 of FIGS. 8 and 9 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. The mobile telephone 12 also includes an RFID tag 60 for use in the implementation of the present invention. Individual circuits and elements are all of a type well known in the art, for example in the Nokia range of mobile telephones.

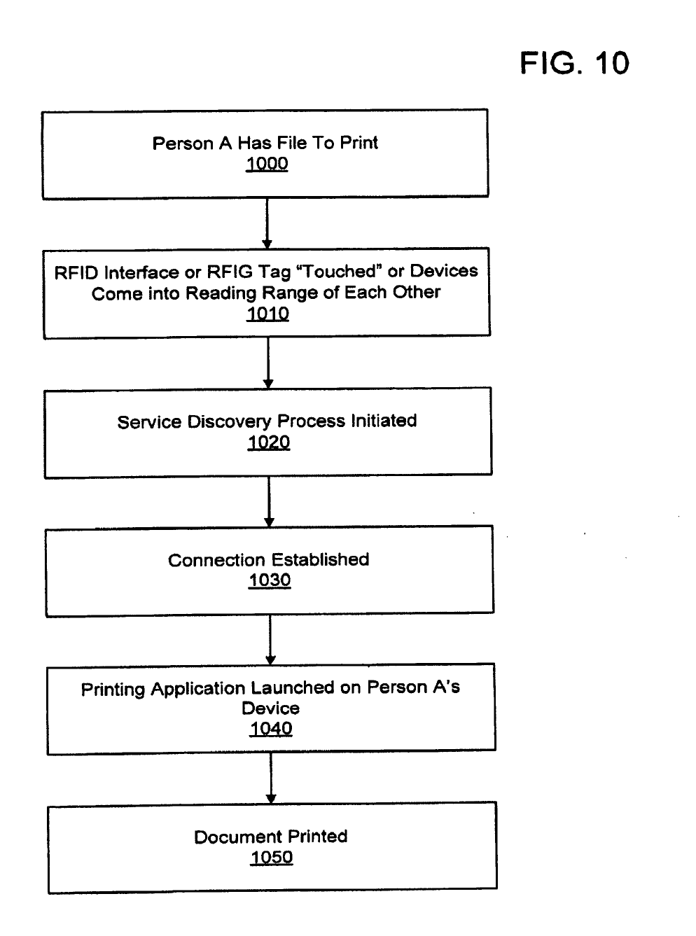

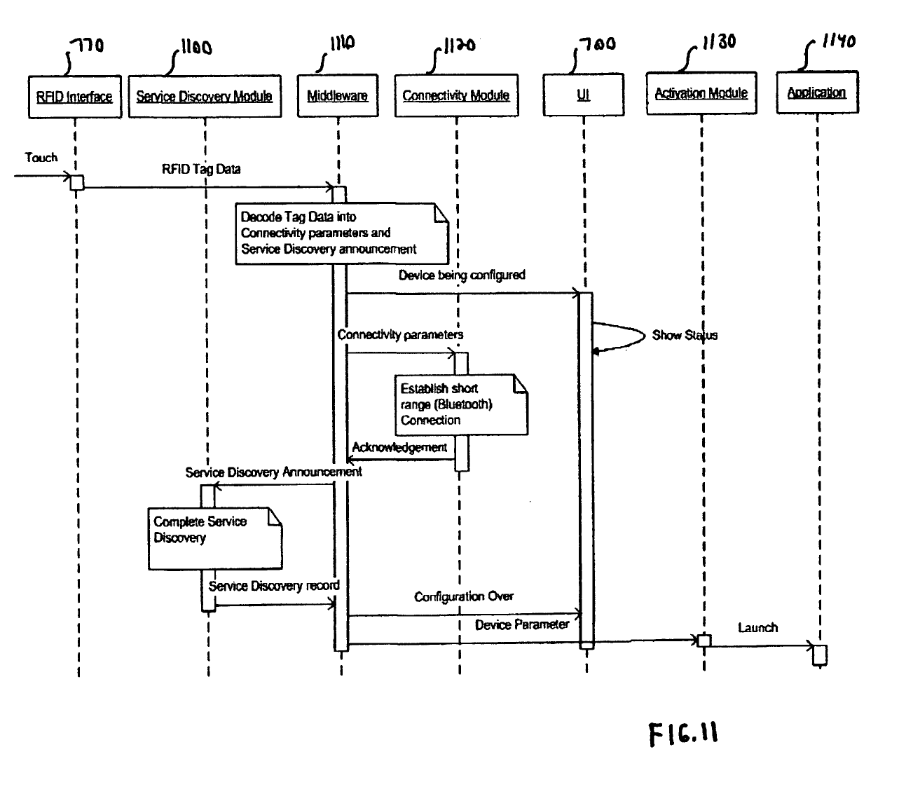

FIGS. 10, 12 and 14 are flow charts showing various use cases for the RFID system of the present invention. In these use cases, it is assumed that once the discovery is initiated by the tag, the devices will communicate via a wireless link such as Bluetooth or WLAN systems in order to complete the discovery, as defined by UPnP standards, and exchange data.

FIG. 10 is a flow chart showing a “touch to print” scenario. In this scenario and at step 1000, Person A has a file on his mobile PDA which he wants to print. At step 1010, Person A touches a printer RFID tag/interface with a mobile device RFID interface, or Person A brings RFID interfaces of a printer and a mobile device into close proximity/within reading range ofeach other. Prior to this step, the nearby printer has not been configured on the mobile PDA. At step 1020 and as a result of step 1010, a service discovery process is initiated by the mobile PDA. At step 1030, the printer and the mobile PDA establish a connection. At step 1040, a printing application is launched on Person A's mobile PDA. At step 1050, Person A selects the file to be printed through a printer dialog box now on the mobile PDA. At step 1050, the document is then printed on the printer.

FIG. 11 is a signal flow diagram showing details of the “touch to launch” scenario for the process of FIG. 10. Upon a “touch” of the RFID device interface module 770, RFID tag data is transmitted to middleware 1110. At this point, the tag data is decoded into connectivity parameters and a service discovery announcement. As the device is being configured, the status of this process is shown at the user interface 700. The connectivity parameters are used by a connectivity module 1120 to establish a short range connection (a Bluetooth connection in one embodiment of the invention.) When this connection is made, an acknowledgment is provided to the middleware 1110, which proceeds to provide a service discovery announcement to a service discovery module 1100. Once service discovery is completed, the service discovery record is provided to the middleware 1110. An activation module 1130 then proceeds to launch the relevant printing application 1140. The user/Person A then proceeds to select the file to print through the printing application interface. It should also be noted that the file can be selected before the connection is established.

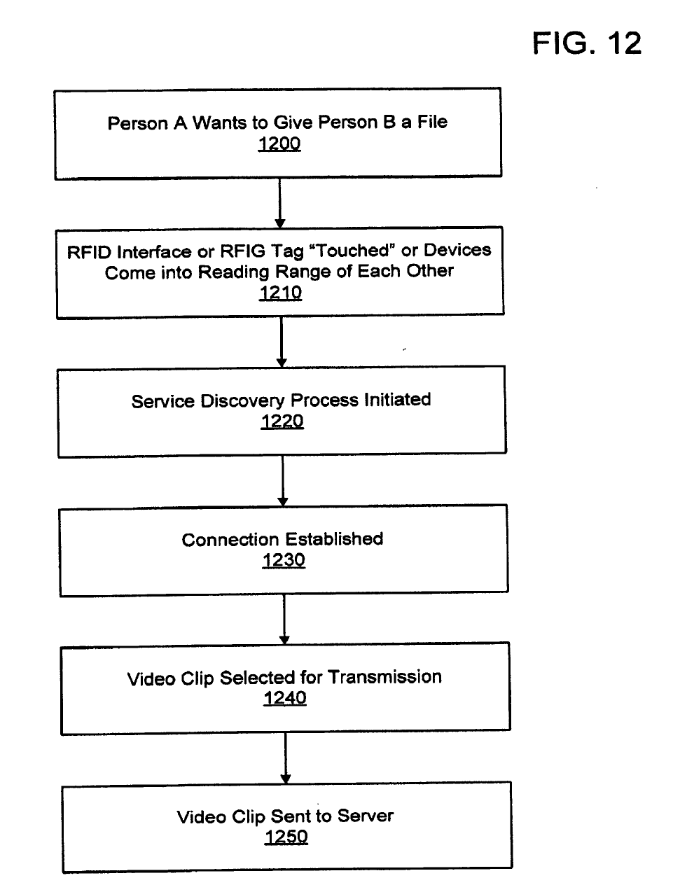

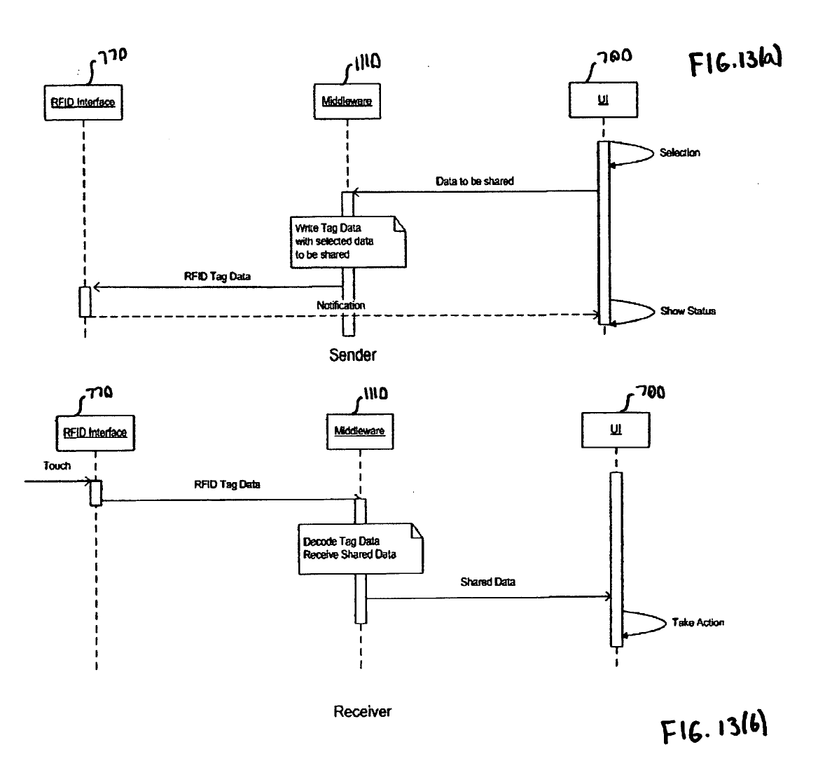

FIG. 12 is a flow chart showing a “touch to share” use scenario. At step 1200, Person A is visiting Person B and wants to give person B a video clip from his recent vacation. The video clip is stored on Person A's mobile telephone, and he wants to transfer it to Person B's media server. At step 1210, Person A touches a home media server RFID interface or RFID tag with a mobile telephone RFID interface, or Person A brings the RFID interfaces of a home media server and the mobile telephone into close proximity/within reading range of each other. At step 1220, a service discovery process is initiated as a result of this actuation. At step 1230, the two devices establish a connection with each other. At step 1240, Person A then selects the video clip he wants to share and then drags and drops the clip on the media server icon on his display. At step 1250, the video clip then is sent to the server. It should also be noted that the video clip to be shared can be selected before the connection is established.

FIG. 13(a) is a signal flow diagram showing details of a “touch to share” process from a sender's perspective, where both the sending device and the receiving device include their own respective user interface. Upon selection at the user interface 700, the data to be shared is transmitted to the middleware 1110, where the data is written in an appropriate tag format. This RFID tag data is then provided to the RFID device interface module 770. A notification is then provided back to the user interface 700, which is then able to show the status of the connection. FIG. 13(b) is a signal flow diagram showing details of the “touch to share” process of FIG. 13(a) from a receiver's perspective. When the receiver's RFID device interface module 770 is “touched,” the RFID tag data of the sending device is transmitted to the middleware 1110. At this point, the tag data is decoded, and shared data is received. The shared data is then provided to the user interface 700, and the desired action is taken.

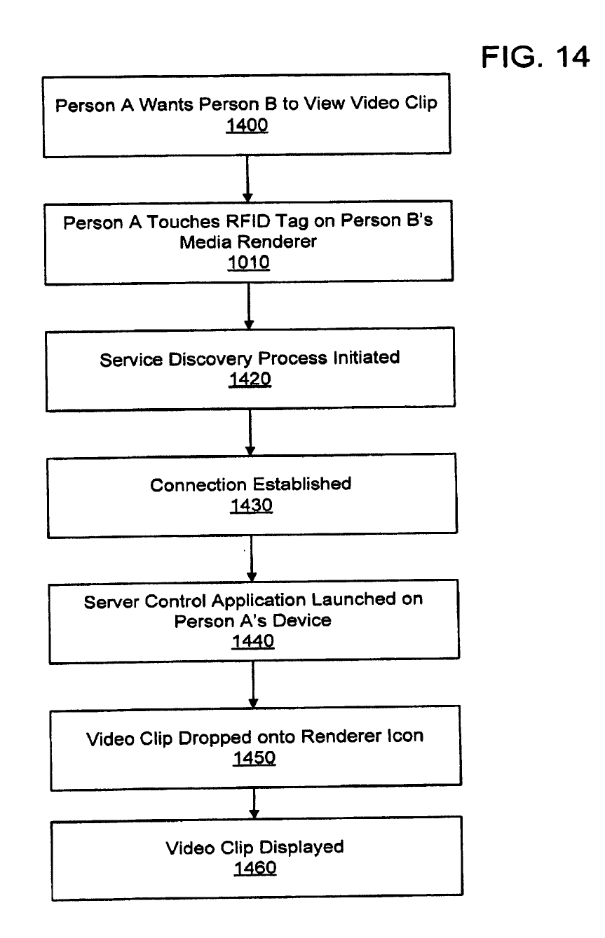

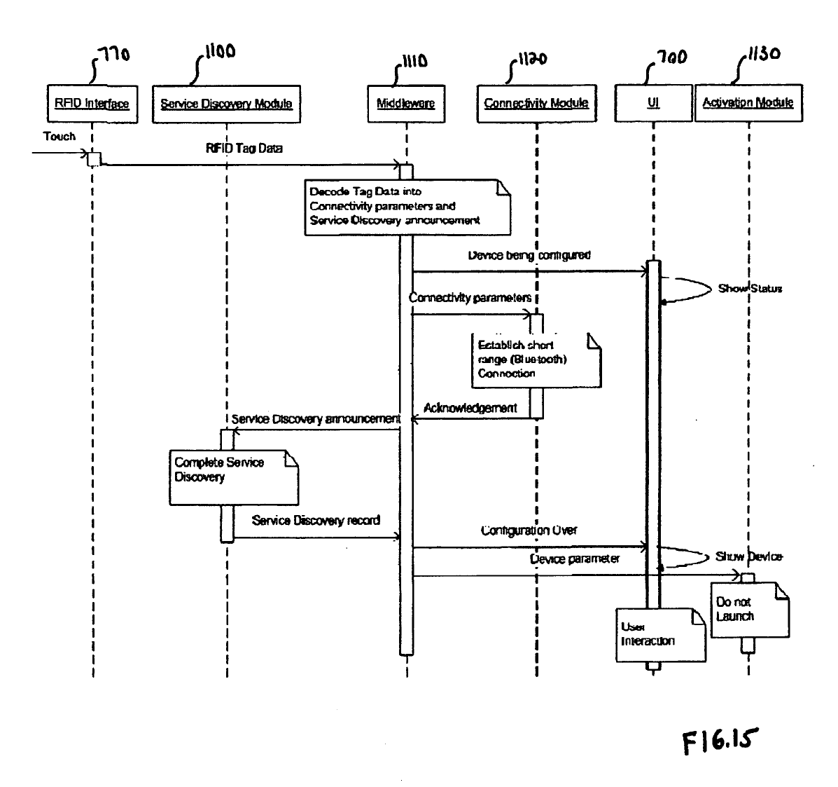

FIG. 14 is a flow chart showing a “touch to interact” scenario involving multiple devices. At step 1400, Person A wants to show Person B the video clip that was transferred in the process of FIG. 12. At this point, Person A has already discovered Person A's media server. At step 1410, Person A touches the hot spot or RFID tag on Person A's media renderer, which can comprise a television, for example. As a result of this touch, a service discovery process is initiated at step 1420 and, at step 1430, the two devices establish a connection. Once a connection has been established, then Person B's telephone can interact with both the media server and the renderer. At step 1440, Person A launches the server control application and selects the video clip. At step 1450, Person A drops the video clip on the renderer icon on his telephone display. Once this step has been completed, the video is ready for rendering and, at step 1460, the video clip is displayed.

FIG. 15 is a signal flow diagram showing details of the “touch to interact” process of FIG. 14. Upon a “touch” of the RFID device interface module 770, RFID tag data is transmitted to the middleware 1110. At this point, the tag data is decoded into connectivity parameters and a service discovery announcement. As the device is being configured, the status of this process is shown at the user interface 700. The connectivity parameters are used by the connectivity module 1120 to establish a short range connection (a Bluetooth connection in one embodiment of the invention.) When this connection is made, an acknowledgment is provided to the middleware 1110, which proceeds to provide a service discovery announcement to the service discovery module 1100. Once service discovery is completed, the service discovery record is provided to the middleware 1110. At this point, user interaction is permissible.

The present invention is described in the general context of method steps, which may be implemented in one embodiment by a program product including computer-executable instructions, such as program code, executed by computers in networked environments.

Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module” as used herein, and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A RFID tag including a plurality of data, the plurality of data comprising:
a message header;
a NDEF header; and
a record, including
a ‘type’ sub-record identifying the structure and semantics of the record,
a “record content” sub-record containing content data, and
a ‘length’ sub-record identifying the length of the record content sub-record,
wherein the record content sub-record comprises a name-length-default values field and a data field, the name-length-default values field including a first byte, and wherein the first byte includes a first bit, a second bit, a third bit, a fourth bit, a fifth bit, a sixth bit, a seventh bit and an eighth bit.

2. The RFID tag of claim 1, wherein, if the eighth bit of the first byte includes a value of zero, then the name-length-default values field consists of only the first byte.

3. The RFID tag of claim 2, wherein the fourth bit, the fifth bit, the sixth bit, the seventh bit and the eighth bit indicates the sub-record data length.

4. The RFID tag of claim 1, wherein, if the eighth bit of the first byte includes a value of one, then the name-length-default values field consists of the first byte and a second byte.

5. The RFID tag of claim 4, wherein the fourth bit, the fifth bit, the sixth bit, the seventh bit, the eighth bit, and the second byte indicates the sub-record data length.

6. The RFID tag of claim 1, wherein the first bit, the second bit, and the third bit are populated to indicate the name of the record content sub-record.

7. The RFID tag of claim 6, wherein the first bit, the second bit, and the third bit are populated to indicate that the sub-record is a cache-control sub-record, and wherein at least one of the fifth bit, the sixth bit, the seventh bit and the eighth bit are populated to indicate a cache control value.

8. The RFID tag of claim 6, wherein the first bit, the second bit, and the third bit are populated to indicate that the sub-record is a “nts” sub-record, and wherein one bit is used to indicate either a “ssdp:bye-bye” or a “ssdp:alive” value.

9. The RFID tag of claim 6, wherein the first bit, the second bit, and the third bit are populated to indicate that the sub-record is a server sub-record, and wherein at least one of the fourth bit, the fifth bit, the sixth bit, the seventh bit, and the eighth bit are used to identify properties of the server.

10. The RFID tag of claim 6, wherein the first bit, the second bit, and the third bit are populated to indicate that the sub-record is a notification sub-record.

11. The RFID tag of claim 6, wherein the first bit, the second bit, and the third bit are populated to indicate that the sub-record is a device/service type sub-record.

12. The RFID tag of claim 6, wherein the first bit, the second bit, and the third bit are populated to indicate that the sub-record is a url location sub-record.

13. The RFID tag of claim 1, wherein the information on the RFID tag includes connectivity parameters and a service discovery announcement.

14. The RFID tag of claim 1, wherein the record comprises a url sub-record comprising a url name-length-default values field having a first byte, the first byte including a first bit, a second bit, a third bit, a fourth bit, a fifth bit, a sixth bit, a seventh bit and an eighth bit, and wherein the sixth bit, the seventh bit, and the eighth bit of first byte of the url name-length-default values field are used to indicate the URL address of the underlying content.

15. The RFID tag of claim 14, wherein, if the fifth bit of the first byte of the url name-length-default values field has a value of ‘1’, then the resulting URL is prefixed with http://, and if the fifth bit has a value of ‘0’, then the fifth bit is ignored.

16. A method of establishing a connection between a first electronic device and a second electronic device, comprising:
reading an RFID tag on the second electronic device,
having the first electronic device initiate a service discovery process in response to the reading of the RFID tag; and
establishing a connection between the first electronic device and the second electronic device using information contained on the RFID tag,
wherein the information on the RFID tag includes:
a message header;
an NDEF header; and
a record, including
a ‘type’ sub-record identifying the structure and semantics of the record,
a “record content” sub-record containing content data, and
a ‘length’ sub-record identifying the length of the record content sub-record.

17. The method of claim 16, wherein the record content sub-record comprises a name-length-default values field and a data field, the name-length-default values field including a first byte, and wherein the first byte includes a first bit, a second bit, a third bit, a fourth bit, a fifth bit, a sixth bit, a seventh bit and an eighth bit.

18. The method of claim 16, wherein, if the eighth bit of the first byte includes a value of zero, then the name-length-default values field consists of only the first byte.

19. The method of claim 18, wherein at least one of the fourth bit, the fifth bit, the sixth bit, the seventh bit and the eighth bit indicates the sub-record data length.

20. The method of claim 16, wherein, if the eighth bit of the first byte includes a value of one, then the name-length-default values field consists of the first byte and a second byte.

21. The method of claim 20, wherein at least one of the fourth bit, the fifth bit, the sixth bit, the seventh bit, the eighth bit, and the second byte indicates the sub-record data length.

22. The method of claim 17, wherein the first bit, the second bit, and the third bit are populated to indicate the name of the record content sub-record.

23. The method of claim 22, wherein the first bit, the second bit, and the third bit are populated to indicate that the sub-record is a cache-control sub-record, and wherein the fifth bit, the sixth bit, the seventh bit and the eighth bit are populated to indicate a cache control value.

24. The method of claim 22, wherein the first bit, the second bit, and the third bit are populated to indicate that the sub-record is a “nts” sub-record, and wherein the eighth bit is used to indicate either a “ssdp:bye-bye” or a “ssdp:alive” value.

25. The method of claim 22, wherein the first bit, the second bit, and the third bit are populated to indicate that the sub-record is a server sub-record, and wherein the fourth bit, the fifth bit, the sixth bit, the seventh bit, and the eighth bit are used to identify properties of the server.

26. The method of claim 22, wherein the first bit, the second bit, and the third bit are populated to indicate that the sub-record is a notification sub-record.

27. The method of claim 22, wherein the first bit, the second bit, and the third bit are populated to indicate that the sub-record is a device/service type sub-record.

28. The method of claim 22, wherein the first bit, the second bit, and the third bit are populated to indicate that the sub-record is a url location sub-record.

29. The method of claim 22, wherein the information on the RFID tag includes connectivity parameters and a service discovery announcement.

30. A RFID tag including a plurality of data, the plurality of data comprising:
a message header;
a NDEF header; and
a record, including:
a ‘cc’ sub-record identifying a cache control max age sub-record type of the record,
a ‘nts’ sub-record having a value of either “ssdp:alive” or “ssdp:bye-bye”,
a ‘server’ sub-record identifying the an operating system name and version, UPnP/1.0, product name, and version, and
a ‘nt’ sub record serving as a device notifier.

31. The RFID tag of claim 30, wherein the record includes a ‘uuid’ sub-record, the ‘uuid’ sub-record being used with the ‘nt’ subrecord to reconstruct a USN field.

32. The RFID tag of claim 30, wherein the record includes a ‘location’ sub-record containing a URL where a device description XML document is stored.

33. The RFID tag of claim 32, wherein the ‘location’ sub-record has a variable length.

34. The RFID tag of claim 30, wherein the ‘cc’ sub-record has a length of one byte, the ‘nts’ sub-record has a length of one byte, the ‘server’ sub-record has a variable length, and the ‘nt’ sub-record has a variable length.
